(19) United States
(12) Patent Application Publication
(10) Pub. No.: US 2022/0050906 A1
(43) Pub. Date: Feb. 17, 2022

(54) METHODS AND APPARATUS FOR DOCUMENT SHARING

(71) Applicant: Arm Cloud Technology, Inc, San Jose, CA (US)

(72) Inventors: Dominic Phillip MULLIGAN, Cottenham (GB); Hanno BECKER, Cambridge (GB); Mathias Sven Lucien Alain BROSSARD, Austin, TX (US); Derek Del MILLER, Austin, TX (US)

(21) Appl. No.: 16/990,276

(22) Filed: Aug. 11, 2020

(51) Int. Cl. G06F 21/62; H04L 9/08; G06F 16/176

(52) U.S. Cl. CPC G06F 21/6209; G06F 16/176; H04L 9/085

(57) ABSTRACT

Aspects of the present disclosure relate to an apparatus comprising secure enclave circuitry and document owner circuitry. The document owner circuitry is configured to determine a document to be shared, generate a plurality of share data units, transmit each share data unit of the plurality of share data units to a corresponding shareholder device, and provision the secure enclave circuitry with data indicative of the document to be shared. The secure enclave circuitry is configured to receive putative share data units from at least one of the corresponding shareholder devices, determine whether the received putative share data units satisfy a sharing policy, and responsive to the received putative share data units satisfying the sharing policy and based on the data indicative of the document to be shared, provide the document to be shared to said at least one of the corresponding shareholder devices.

### BACKGROUND

The present technique relates to the field of cryptographic techniques, in particular in relation to the encryption and decryption of documents. It may be desirable to share an encrypted document with multiple parties. For example, a decryption key for an encrypted document could be provided to each such party. This would allow each party to independently decrypt the document. It may be desirable for decryption to be possible only after the consent of all of the users, or of a minimum number of the users. There is therefore a desire for methods and systems for providing more sophisticated multi-party secret sharing, and for improving the effectiveness and efficiency thereof.

### SUMMARY

At least some examples provide an interconnect apparatus comprising:

secure enclave circuitry; and

document owner circuitry to:
determine a document to be shared;
generate a plurality of share data units;
transmit each share data unit of the plurality of share data units to a corresponding shareholder device; and
provision the secure enclave circuitry with data indicative of the document to be shared,

the secure enclave circuitry being configured to, based on the data indicative of the document to be shared:
receive putative share data units from at least one of the corresponding shareholder devices;
determine whether the received putative share data units satisfy a sharing policy; and
responsive to the received putative share data units satisfying the sharing policy, provide data based on the document to be shared to at least one recipient device.

Further examples relate to a method comprising:

determining a document to be shared;

generating a plurality of share data units;

transmitting each share data unit of the plurality of share data units to a corresponding shareholder device; and

provisioning secure enclave circuitry with data indicative of the document to be shared;

receiving, at the secure enclave circuitry, putative share data units from at least one of the corresponding shareholder devices;

determining, by the secure enclave circuitry, whether the received putative share data units satisfy a sharing policy; and

responsive to the received putative share data units satisfying the sharing policy, providing, by the secure enclave circuitry, data based on the document to be shared to at least one recipient device.

Further examples relate to an apparatus comprising:

secure enclave means; and

document owner means to:
determine a document to be shared;
generate a plurality of share data units;
transmit each share data unit of the plurality of share data units to a corresponding shareholder device; and
provision the secure enclave means with data indicative of the document to be shared,

the secure enclave means being configured to, based on the data indicative of the document to be shared:
receive putative share data units from at least one of the corresponding shareholder devices;
determine whether the received putative share data units satisfy a sharing policy; and

responsive to the received putative share data units satisfying the sharing policy, provide data based on the document to be shared to at least one recipient devices.

Further aspects, features and advantages of the present technique will be apparent from the following description of examples, which is to be read in conjunction with the accompanying drawings.

### BRIEF DESCRIPTION OF THE DRAWINGS

FIG. 1 schematically shows a system according to an example.

FIG. 2 depicts a method according to an example.

FIG. 3 depicts a method according to an example.

FIG. 4 depicts a method according to an example.

FIG. 5 schematically depicts a communication flow between a relying party and secure enclave circuitry according to an example.

FIG. 6 schematically depicts a method according to an example.

### DESCRIPTION OF EXAMPLES

As stated above, an example apparatus comprises secure enclave circuitry and document owner circuitry. The document owner circuitry is configured to determine a document to be shared, and to generate a plurality of share data units associated with the document. The document is to be shared between shareholder devices. The document is an amount of data, for example a file, a number of files, a portion of one or more files, or other data. The document owner circuitry transmits each such share data unit to a corresponding shareholder device. The document owner circuitry provisions the secure enclave circuitry with data indicative of the document to be shared. For example, a copy of the document may be provided to the secure enclave circuitry. This copy may be plaintext or encrypted. As another example, data enabling the document to be re-created may be provided to the secure enclave circuitry. Thus, each shareholder device is provided with a corresponding share data unit, and the secure enclave circuitry is provided with data indicative of the document to be shared.

One or more of the shareholder devices (or their users) decides to retrieve the document. Each such shareholder device then transmits its share data unit to the secure enclave circuitry. The secure enclave circuitry is configured to receive these share data units (which may be initially considered as putative share data units). The secure enclave circuitry then determines whether the received putative share data units satisfy a sharing policy. For example, the sharing policy may require at least a given number of share data units to be provided, such as all of the share data units, or more than half of the share data units, or any other particular number or fraction of share data units.

This determination may also comprise verifying the identity of the putative share data units, i.e. verifying that they match the share data units. The sharing policy may be defined in the data indicative of the document to be shared or may be separately provided to the secure enclave circuitry, for example from the document owner circuitry.

The secure enclave circuitry is configured to, responsive to the received putative share data units satisfying the sharing policy and based on the data indicative of the document to be shared, provide data based on the document to be shared to at least one recipient device. This data may for example comprise the document to be shared in its entirety, or a part thereof. For example, the data may comprise a chapter of a larger document. Alternatively or additionally, the data may comprise data indicative of a particular aspect of the document, for example statistical data relating to numerical data within the document. For ease of description, when the text below refers to the document, it will be understood that the same techniques can be applied to such data based on the document.

The recipient devices may include one or more of the shareholder devices. For example, the recipient devices may be the shareholder devices from which putative share data units were received. In this manner, it can be assured that the dissemination will satisfy the sharing policy and that, for example, a given shareholder device will not be able to violate the sharing policy and access the document without the agreement and knowledge of the other shareholder devices (or the requisite number thereof). The storage of the document to be shared in the secure enclave circuitry prevents access to the document until the sharing policy has been satisfied, for example by way of an encryption/protection engine of the secure enclave circuitry. The secure enclave circuitry may for example be configured to block transmission of the document to be shared to parties other than the shareholder devices from which putative share data units, which satisfy the sharing policy, have been received. This ensures that the document is not disseminated in any way other than as defined by the sharing policy.

In an example, the data indicative of the document to be shared comprises computer program instructions defining the receiving, determining, and providing to be performed by the secure enclave circuitry. The data can thus serve to configure the secure enclave circuitry in terms of the actions that it is to take, as well as provisioning the secure enclave circuitry with the document. Efficiency is thereby improved, as well as allowing the document owner circuitry to define the actions that are to be performed (for example including defining the sharing policy) and to have assurance that those actions will be performed as expected.

There are various ways in which the secure enclave circuitry can verify the putative share data units. In one example, the secure enclave circuitry is configured to receive, from the document owner circuitry, reference share data units indicative of the generated plurality of share units. The reference share units may for example be copies of the share data units provided to the shareholder devices. The secure enclave circuitry can then verify that the received putative share data units match the corresponding reference share data units.

As indicated above, various sharing policies can be implemented. For example, the sharing policy may comprise a share voting policy. Example share voting policies include a minimum number of putative share data units to be received for the share voting policy to be satisfied, a minimum proportion of putative share data units to be received for the share voting policy to be satisfied, and at least one combination of putative share data units to be received for the share voting policy to be satisfied. Complex share voting policies can be implemented if desired, including any share voting policy that can be algorithmically defined. The present apparatus is thus more versatile than comparative systems which do not support algorithmic definition of arbitrary security policies.

In an example, the document owner circuitry is configured to generate each share data unit, of the plurality of share data units, as a random number of predefined size. The share data unit can thus be efficiently generated and have a very small likelihood of being correctly guessed by a party other than the corresponding shareholder device. In this way, the share data units can function as tokens without having a particular algorithmic relationship to the document to be shared.

In an alternative example, the document owner circuitry is configured to encrypt the document to be shared, to produce an encrypted document and an associated decryption key (the encryption being based on a corresponding private encryption key). The decryption key may be mathematically equivalent to a public key in an asymmetrical encryption algorithm, but it is not made public. Instead, the document owner circuitry generates, based on the decryption key, a plurality of key shares. The document owner circuitry generates each share data unit of the plurality of share data units as one of said plurality of key shares. In this example, the data indicative of the document to be shared may comprise the encrypted document. The secure enclave circuitry may be configured to determine whether the received putative share data units satisfy the sharing policy by attempting to use the putative share data units to decrypt the encrypted document. The putative share data units can thus be efficiently verified, whilst adding a layer of protection to the document by way of encryption: if the putative share data is not authentic, the document will not decrypt. This also allows efficient sharing of future documents: these can be encrypted using the same private key, thereby allowing the shareholder devices to re-use their existing key shares. The repeated transmission of key shares can thereby be avoided, reducing communication bandwidth requirements. However, this example is limited to the specific forms of sharing policy which are supported by the particular scheme that is used to generate the key shares, which may not support arbitrary algorithmically defined sharing policies. For example, the document owner circuitry may be configured to generate the plurality of key shares by applying a Shamir's Secret Sharing algorithm, which allows a sharing policy based on a minimum number of key shares being provided. In one example in which key sharing is implemented, the secure enclave circuitry is configured to prevent transmission of the encrypted document to devices external to the secure enclave circuitry, other than the recipient device or devices. This prevents shareholder devices from combining their key shares and obtaining the plaintext document independently of the secure enclave circuitry. It can thereby be ensured that the document owner circuitry maintains control over the parties that are permitted to access the document (for example, at a later time, the document owner circuitry could instruct the secure enclave circuitry to delete the encrypted document and thus prevent further access thereto).

In an example, the secure enclave circuitry is configured to provide the document to be shared to said at least one of the corresponding shareholder devices responsive to determining that the received putative share data units are received within a time window. For example, the time window may have a start time based on a time of receiving a first putative share data unit of the received putative share data units. This ensures that after receiving a given share data unit, the secure enclave circuitry does not wait an arbitrary long time for the subsequent share data units to be provided. This adds confidence that there is a genuine agreement between the shareholder devices (or the users thereof) to access the document.

In an example, the secure enclave circuitry is configured to, responsive to receiving an attestation request from the document owner circuitry, perform with the document owner circuitry an attestation process in respect of computer program instructions to be executed by the secure enclave. The document owner circuitry can thus be assured that the document will be handled as expected and, for example, that the security and confidentiality of the document will be ensured.

Alternatively or additionally, the secure enclave circuitry may be configured to, responsive to receiving an attestation request from a given one of the shareholder devices, perform with the given one of the shareholder devices an attestation process in respect of the data indicative of at least one of the document to be shared and computer program instructions to be executed by the secure enclave circuitry. This provides confidence to the shareholder devices that the secure enclave circuitry will indeed provide the authentic document once they have provided their share data units.

Examples of the present disclosure will now be described with reference to the drawings.

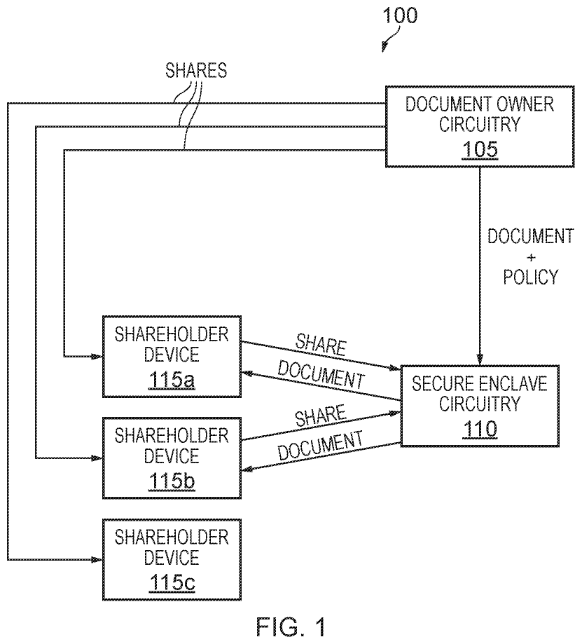

FIG. 1 schematically shows a system 100 according to an example of the present disclosure. The system comprises document owner circuitry 105, secure enclave circuitry 110 and shareholder devices 115a, 115b, 115c.

The document owner circuitry 105 is to share a document with the shareholder devices 115a-115c. However, the shareholder devices 115a-115c are not to access the document until a sharing policy is satisfied. In the present example, if two out of the three shareholder devices 115a-115c wish to access the document, the document is to be provided to those shareholder devices. However, a single shareholder device is not permitted to access the document alone. In alternative examples, other sharing policies may be implemented. For example, it may be desirable for the document to be made available when all shareholder devices 115a-115c wish to access the document, or when a single share device wishes to access the document. Alternatively, more complex sharing policies (indeed, any policy which can be algorithmically defined, for example using “if” statements) may be implemented. For example, it may be desirable for the document to be made available if devices 115a and 115b in combination (but not individually) wish to access the document, whilst simultaneously making the document available if device 115c alone wishes to access the document.

In order to facilitate the sharing policy, the document owner circuitry 105 provisions the secure enclave circuitry 110 with the document, and provides a definition of the sharing policy to the secure enclave circuitry 110. The document owner circuitry 105 also transmits a share data unit to each shareholder device 115a-115c. In this example, the share data units are random numbers which the document owner circuitry 105 also provides to the secure enclave circuitry 110 as part of the sharing policy.

The shareholder devices 115a-115c determine whether to attempt to access the document. For example, shareholder devices 115a and 115b (or the users thereof) may agree that together they will attempt to access the document. Shareholder devices 115a and 115b then transmit their shares to the secure enclave circuitry 110, for example via a secure communication channel.

The secure enclave circuitry 110 confirms whether the received shares satisfy the sharing policy. In the present example, as stated above the policy is that the document is to be provided if two shareholder devices 115a-115c agree to access the document. The policy is thus satisfied, and the document is provided to the devices 115a and 115b. Conversely, if a single shareholder device 115a-115c attempted to access the document, the policy would not be satisfied and the document would not be provided. The secure enclave circuitry 110 may for example issue an error message and/or keep a log in response to such failed attempts.

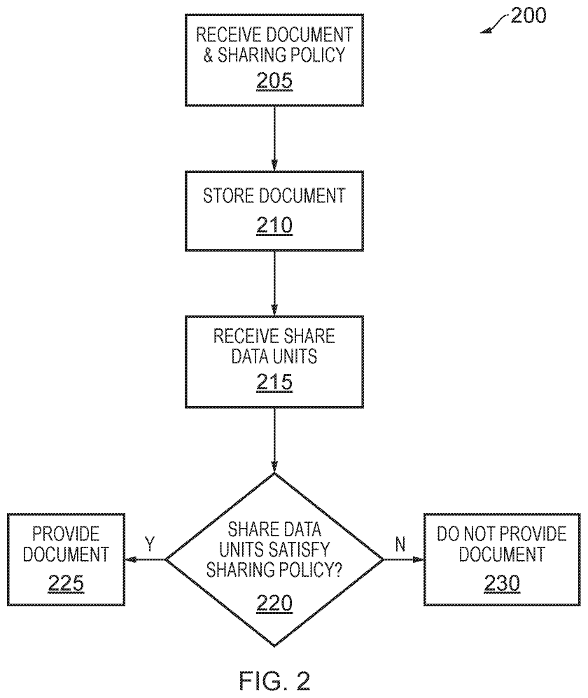

FIG. 2 depicts a method 200 according to an example of the present disclosure. The method 200 may for example be implemented by the secure enclave circuitry 110 of FIG. 1.

At block 205, a document and associated sharing policy are received (for example from the document owner circuitry 105 of FIG. 1).

At block 210, the document is stored. The document may for example be stored in a secure storage of the secure enclave circuitry 110 and/or encrypted.

At block 215, putative share data units are received from shareholder devices (such as the shareholder devices 115a-115c of FIG. 1).

At block 220, it is determined whether the received share data units satisfy the sharing policy. For example, this may include verifying that the received putative share data units correspond to valid reference share units that were received as part of the sharing policy.

If it is determined that the putative share data units satisfy the sharing policy, flow proceeds to block 225 where the document is provided to the shareholder devices from which the putative share data units were received.

Conversely, if it is determined that the putative share data units do not satisfy the sharing policy (for example because they are invalid, or because they do not correspond to an accepted combination of shareholder devices), flow proceeds to block 230 where the document is not provided.

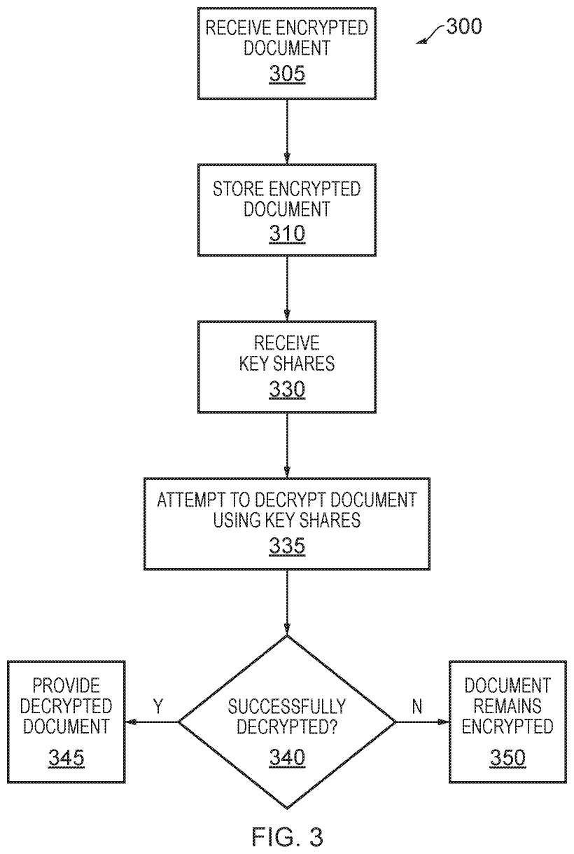

FIG. 3 depicts a method 300 according to an example of the present disclosure. The method 300 may for example be implemented by the secure enclave circuitry 110 of FIG. 1.

At block 305, an encrypted document is received (for example from the document owner circuitry 105 of FIG. 1). A decryption key associated with the encryption has been converted by the document owner circuitry 105 into key shares, for example using a Shamir's secret sharing algorithm. The conversion is such that a given number of key shares (which may be less than the total number of key shares) are required to decrypt the document. Each key share has been provided from the document owner circuitry 105 to a corresponding shareholder device 115a-115c.

At block 310, the encrypted document is stored, for example in a secure storage of the secure enclave circuitry 110.

At block 330, putative key shares are received from shareholder devices 115a-115c.

At block 335, an attempt is made to decrypt the document using the received putative key shares.

At block 340, it is determined whether the decryption attempt was successful. If so, flow proceeds to block 345 where the decrypted document is provided to the shareholder devices 115a-115c from which the putative key shares were received.

Conversely, if it is determined that the decryption attempt was unsuccessful, flow proceeds to block 350 where the document remains encrypted.

Block 340 can thus be interpreted as applying an implicit sharing policy requiring a given number of shareholder devices 115a-115c to agree to access the document in order for the document to be provided. As indicated above, the method 300 allows efficient sharing of future documents: these can be encrypted using the same private key, thereby allowing the shareholder devices to re-use their existing key shares. However, this example is limited to the specific forms of implicit sharing policy which are supported by the particular scheme that is used to generate the key shares.

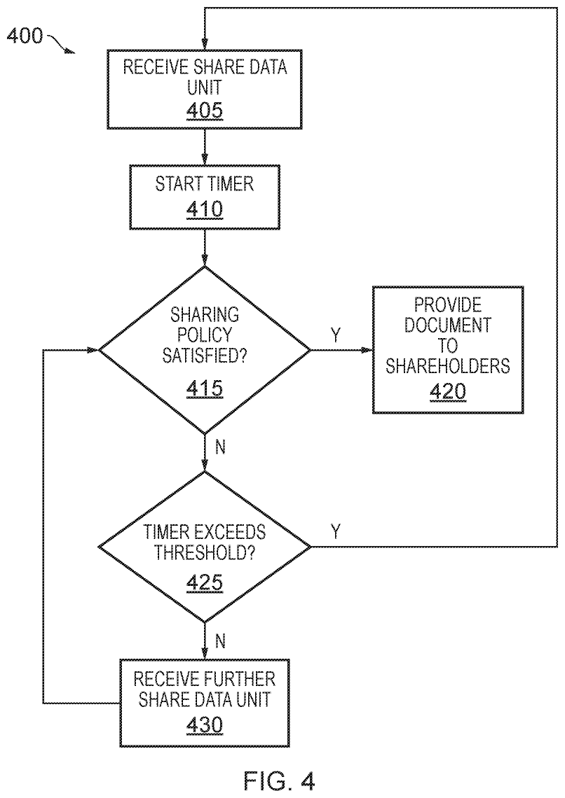

FIG. 4 depicts a method 400 according to an example of the present disclosure. The method 400 may for example be implemented by the secure enclave circuitry 110 of FIG. 1. The method 400 can be considered as an extension to the methods 200, 300 of FIGS. 2 and 3, beginning from the receipt of putative share data units or key shares at block 215/330. The method is described in terms of share data units (i.e. the language of FIG. 2), but can equally well be applied to the method of FIG. 3.

At block 405, putative share data units are received from shareholder devices 115a-115c.

At block 410, a timer is started.

At block 415, it is determined whether the sharing policy has been satisfied (e.g. because sufficient valid putative share data units have been received). If so, flow proceeds to block 420 where the document is provided to the shareholder devices 115a-115c.

Otherwise, flow proceeds to block 425 where it is determined whether the timer has exceeded a threshold. The threshold may be predefined, or may be defined in the sharing policy.

If the threshold has not been exceeded, flow proceeds to block 430 where a further share data unit is received, after which flow returns to block 415.

If the threshold has been exceeded, flow returns to block 405 and the method restarts.

The method 400 thus allows a requirement that all putative share data units are received within the time window. This can help ensure that there is genuine agreement between the shareholder devices 115a-115c as to when to access the document, as well as ensuring that the secure enclave circuitry 110 does not wait an arbitrarily long time to receive subsequent share data units following an attempt by a single shareholder device 115a-115c to access the document.

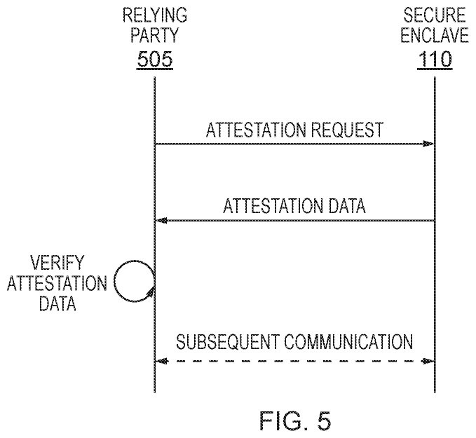

FIG. 5 schematically depicts a communication flow between a relying party 505 and secure enclave circuitry 110, according to an example of the present disclosure. The relying party 505 may be document owner circuitry 105 or may be a shareholder device 115a-115c. Both of these options may be implemented within the same system. The communication flow allows for the secure enclave to attest to the authenticity of actions that it will perform.

The relying party 505 issues an attestation request to the secure enclave. In return, the secure enclave provides attestation data to the relying party.

If the relying party 505 is the document owner circuitry, the attestation data may comprise data indicative of computer program instructions that that secure enclave circuitry 110 is configured to execute. For example, the attestation data may be a hash or digest of these instructions.

If the relying party 505 is the document owner circuitry, the attestation data may similarly comprise data indicative of computer program instructions that that secure enclave circuitry 110 is configured to execute. Alternatively or additionally, the attestation data may comprise data indicative of the document which is to be shared.

The relying party 505 verifies the attestation data. For example, it may compare the received attestation data against reference attestation data, to confirm that the computer program instructions and/or document are as expected. Alternatively or additionally, the relying party 505 may transmit the attestation data to an attestation service configured to confirm the authenticity of received attestation data.

Following successful attestation, the relying party is assured of the authenticity of the computer program instructions/and or document, and thus that the secure enclave circuitry 110 has not been compromised by a malicious attacker. Subsequent communication (for example as described above in relation to FIGS. 1 to 4) can then be performed.

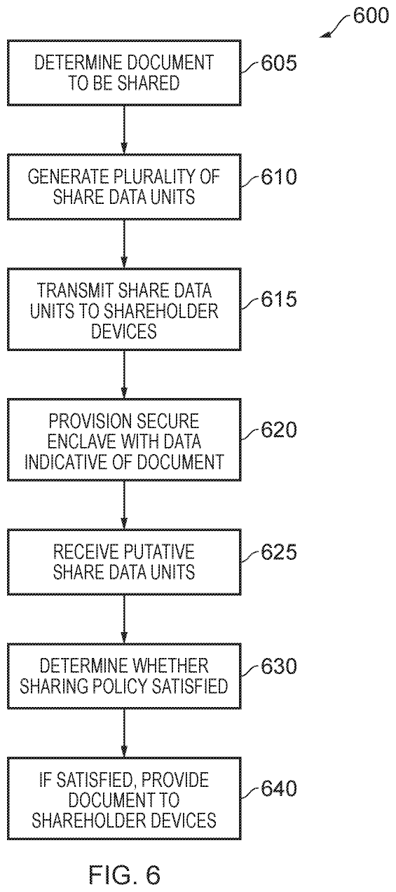

FIG. 6 schematically depicts a method 600 according to an example of the present disclosure. The method may for example be implemented within the system 100 of FIG. 1.

At block 605, a document to be shared is determined by document owner circuitry 105.

At block 610, a plurality of share data units are generated by the document owner circuitry 105.

At block 615, the share data units are transmitted to shareholder devices 115a-115c.

At block 620, the document owner circuitry 105 provisions secure enclave circuitry 110 with the document.

At block 625, putative share data units from the shareholder devices 115a-115c are received by the secure enclave circuitry 110.

At block 630, the secure enclave circuitry 110 determines whether a sharing policy has been satisfied.

At block 640, if the sharing policy has been satisfied, the secure enclave circuitry 110 provides the document to the shareholder devices 115a-115c.

Apparatuses and methods are thus provided for sharing a document between shareholder devices.

From the above description it will be seen that the techniques described herein provides a number of significant benefits. In particular, the present techniques are more efficient and flexible than comparative techniques.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

We claim:

1. An apparatus comprising:
secure enclave circuitry; and
document owner circuitry to:
determine a document to be shared;
generate a plurality of share data units;
transmit each share data unit of the plurality of share data units to a corresponding shareholder device; and
provision the secure enclave circuitry with data indicative of the document to be shared,
the secure enclave circuitry being configured to:
receive putative share data units from at least one of the corresponding shareholder devices;
determine whether the received putative share data units satisfy a sharing policy; and
responsive to the received putative share data units satisfying the sharing policy and based on the data indicative of the document to be shared, provide data based on the document to at least one recipient device.

2. An apparatus according to claim 1, wherein the data indicative of the document to be shared comprises computer program instructions defining the receiving, determining, and providing to be performed by the secure enclave circuitry.

3. An apparatus according to claim 1, wherein the secure enclave circuitry is configured to:
receive, from the document owner circuitry, reference share data units indicative of the generated plurality of share units; and
verify that the received putative share data units match the corresponding reference share data units.

4. An apparatus according to claim 1, wherein the sharing policy comprises a share voting policy.

5. An apparatus according to claim 4, wherein the share voting policy defines at least one of:
a minimum number of putative share data units to be received for the share voting policy to be satisfied;
a minimum proportion of putative share data units to be received for the share voting policy to be satisfied; and
at least one combination of putative share data units to be received for the share voting policy to be satisfied.

6. An apparatus according to claim 1, wherein the document owner circuitry is configured to generate each share data unit, of the plurality of share data units, as a random number of predefined size.

7. An apparatus according to claim 1, wherein the data indicative of the document to be shared comprises a copy of the document to be shared.

8. An apparatus according to claim 7, wherein the copy of the document to be shared is an encrypted copy of the document to be shared.

9. An apparatus according to claim 1, wherein:
said at least one recipient device comprises one or more of said at least one of the corresponding shareholder devices; and
the secure enclave circuitry is configured to block transmission of the document to be shared to parties other than the shareholder devices from which putative share data units, which satisfy the sharing policy, have been received.

10. An apparatus according to claim 1, wherein:
the document owner circuitry is configured to:
encrypt the document to be shared, to produce an encrypted document and an associated decryption key;
generate, based on the decryption key, a plurality of key shares;
generate each share data unit of the plurality of share data units as one of said plurality of key shares.

11. An apparatus according to claim 10, wherein the data indicative of the document to be shared comprises the encrypted document.

12. An apparatus according to claim 11, wherein the secure enclave circuitry is configured to prevent transmission of the encrypted document to devices external to the secure enclave circuitry, other than said at least one recipient device.

13. An apparatus according to claim 10, wherein the secure enclave circuitry is configured to determine whether the received putative share data units satisfy the sharing policy by attempting to use the putative share data units to decrypt the encrypted document.

14. An apparatus according to claim 10, wherein the document owner circuitry is configured to generate the plurality of key shares by applying a Shamir's Secret Sharing algorithm.

15. An apparatus according to claim 1, wherein the secure enclave circuitry is configured to provide the data based on document to be shared to said at least one recipient device responsive to determining that the received putative share data units are received within a time window.

16. An apparatus according to claim 15, wherein the time window has a start time based on a time of receiving a first putative share data unit of the received putative share data units.

17. An apparatus according to claim 1, wherein the secure enclave circuitry is configured to, responsive to receiving an attestation request from the document owner circuitry, perform with the document owner circuitry an attestation process in respect of computer program instructions to be executed by the secure enclave circuitry.

18. An apparatus according to claim 1, wherein the secure enclave circuitry is configured to, responsive to receiving an attestation request from a given one of the shareholder devices, perform with the given one of the shareholder devices an attestation process in respect of at least one of the data indicative of at least one of the document to be shared and computer program instructions to be executed by the secure enclave circuitry.

19. A method comprising:
determining a document to be shared;
generating a plurality of share data units;
transmitting each share data unit of the plurality of share data units to a corresponding shareholder device; and
provisioning secure enclave circuitry with data indicative of the document to be shared;
receiving, at the secure enclave circuitry, putative share data units from at least one of the corresponding shareholder devices;
determining, by the secure enclave circuitry, whether the received putative share data units satisfy a sharing policy; and
responsive to the received putative share data units satisfying the sharing policy, providing, by the secure enclave circuitry, data based on the document to be shared to at least one recipient device.

20. An apparatus comprising:
secure enclave means; and
document owner means to:
determine a document to be shared;
generate a plurality of share data units;
transmit each share data unit of the plurality of share data units to a corresponding shareholder device; and
provision the secure enclave means with data indicative of the document to be shared,
the secure enclave means being configured to, based on the data indicative of the document to be shared:
receive putative share data units from at least one of the corresponding shareholder devices;
determine whether the received putative share data units satisfy a sharing policy; and
responsive to the received putative share data units satisfying the sharing policy, provide data based on the document to be shared to at least one recipient device.
